(19) United States
(12) Patent Application Publication
(10) Pub. No.: US 2025/0033368 A1
(43) Pub. Date: Jan. 30, 2025

(54) LIQUID CONTAINER AND LIQUID CONSUMPTION APPARATUS

(71) Applicant: CANON KABUSHIKI KAISHA, Tokyo (JP)

(72) Inventors: TSUYOSHI SAEKI, Kanagawa (JP); HIDEAKI MATSUMURA, Tokyo (JP); NORIO SAKURAI, Tokyo (JP); SHOTA ASADA, Tokyo (JP); TAIJI MARUYAMA, Kanagawa (JP); HIROMASA TSUTSUMI, Kanagawa (JP); YUSUKE NARATANI, Tokyo (JP); NOBUHIRO TOKI, Kanagawa (JP); ERIKA IYAMA, Kanagawa (JP)

(21) Appl. No.: 18/759,689

(22) Filed: Jun. 28, 2024

(30) Foreign Application Priority Data
Jul. 24, 2023 (JP) 2023-119681

(51) Int. Cl. B41J 2/175

(52) U.S. Cl. CPC B41J 2/17553; B41J 2/17509; B41J 2/17513

(57) ABSTRACT

An embodiment is a liquid container mounted on a liquid consumption apparatus including a liquid ejection head for ejecting a liquid and configured to store the liquid to be supplied to the liquid ejection head. The liquid container includes: a tank chamber to store the liquid; an inlet port which is provided above the tank chamber and into which the liquid is poured; and an outlet port which is provided to face the inside of the tank chamber and from which the liquid from the inlet port is discharged after moving through a channel with air-liquid exchange. Provided that a depth direction is a direction crossing a height direction and a right-left direction of the liquid consumption apparatus, the depth-direction center position of the outlet port is closer to the center of the tank chamber than the depth-direction center position of the inlet port is.

### BACKGROUND

### Field

The present disclosure relates to a liquid container such as an ink tank and more specifically relates to a liquid container including an inlet port for ink replenishment.

### Description of the Related Art

As a liquid container of this type, Japanese Patent Laid-Open No. 2019-104163 describes an ink tank including an inlet port for ink filling, ink channels linearly extending from the inlet port vertically downward, openings each corresponding to an end of each of the ink channels, and a tank unit. Specifically, two ink channels and two openings are provided to exert a gas-liquid exchange function, through which the ink poured from the inlet port flows through the ink channels and the openings and thus the tank unit is replenished with the ink.

### SUMMARY

However, Japanese Patent Laid-Open No. 2019-104163 has a problem that since the ink inlet port is arranged at a front end of the ink tank and the two openings are arranged vertically below the inlet port, so the air-liquid exchange function is easily affected by a change in the ink tank's posture. For example, the ink tank may be tilted because the entire apparatus equipped with the ink tank is tilted during ink replenishment or because the ink tank itself is attached in a posture slightly tilted. In this case, the liquid level in the tank unit relative to the two openings is changed and air-liquid exchange through the two openings is stopped, so that the ink replenishment cannot be performed any more. For this reason, an ink-replenishable amount varies depending on a tilt of the ink tank.

Therefore, the present disclosure has an object to stabilize a replenishment amount of a liquid irrespective of a tilt of a liquid container.

An embodiment of the present invention is a liquid container which is mounted on a liquid consumption apparatus including a liquid ejection head configured to eject a liquid and which is configured to store the liquid to be supplied to the liquid ejection head, the liquid container comprising: a tank chamber configured to store the liquid; an inlet port which is provided above the tank chamber and into which the liquid is poured; and an outlet port which is provided to face an inside of the tank chamber and from which the liquid poured from the inlet port is discharged after moving through a channel along with air-liquid exchange, wherein provided that a depth direction is a direction crossing a height direction and a right-left direction of the liquid consumption apparatus, a depth-direction center position of the outlet port is closer to a center of the tank chamber than a depth-direction center position of the inlet port.

Further features of the present invention will become apparent from the following description of exemplary embodiments with reference to the attached drawings.

### BRIEF DESCRIPTION OF THE DRAWINGS

FIG. 1 is a perspective view of mechanism units of an inkjet printing apparatus according to an embodiment of the present disclosure;

FIG. 2A is a perspective view of an ink tank and FIG. 2B is an exploded view of the ink tank;

FIG. 3A is a front view of the tank case, FIG. 3B is a right-side view of the tank case, FIG. 3C is a left-side view of the tank case, and FIG. 3D is a top view of the tank case;

FIGS. 4A to 4C are views illustrating states in a tank chamber 22 under conditions where the ink tank is tilted by rotating about an X axis;

FIGS. 5A to 5C are schematic views illustrating the insides of tank chambers of ink tanks in the related art; and

FIGS. 6A and 6B are schematic views illustrating the insides of tank chambers of ink tanks according to an embodiment of the present disclosure.

### DESCRIPTION OF THE EMBODIMENTS

Hereinafter, an embodiment of the present invention will be described in details in reference to the accompanying drawings. It should be noted that the following embodiment is not intended to unnecessarily limit the invention according to the scope of claims. Although multiple features are described in the following embodiment, not all of these multiple features are essential to achieve the object of the disclosure, and some of the features may be combined as desired. In addition, in the accompanying drawings, the same or similar constituent elements will be designated with the same reference sign, and repetitive description thereof will be omitted in some cases.

In the present disclosure, “printing” means to form meaningful information such as characters and graphics. In addition, “printing” not only means to form information, but also broadly means to form an image, design, pattern, or the like on a printing medium or to process a printing medium irrespective of whether the formed or processed product is meaningful or not and whether the formed or processed product is noticeable so that humans can perceive it visually. Also, “printing” is sometimes called “character printing” or “recording”.

The term “printing medium” includes not only printing paper for use in general image forming apparatuses but also a wide range of conveyable media such as cloth, plastic, film (OHP), metal plate, glass, ceramics, wood, and leather. Here, a “printing medium” will be also referred to as a “sheet” in some cases.

The term “liquid” can be interpreted broadly as in the above definition of “printing”, and includes an ink to be applied to a printing medium to form an image, design, pattern, or the like, a process liquid to process a surface of a printing medium, a reaction liquid for use for a special treatment on an applied liquid (for example, giving gloss), and so on. Then, the “treatment on an ink” means, for example, solidification or insolubilization of a coloring material in the ink applied to a printing medium.

In the following description, an axis in a main scanning direction of a carriage is defined as an X axis, an axis in a conveyance direction of a printing medium is defined as a Y axis, and an axis in a direction normal to a plane on which a printing apparatus is installed is defined as a Z axis. These axes are orthogonal to each other. The X axis direction is referred to as a “right-left direction (of the printing apparatus as viewed from the front side)”, the Y axis direction is referred to as a “longitudinal direction (depth direction) (of the printing apparatus)”, and the Z axis direction is referred to as a “height direction (of the printing apparatus)”. In addition, a +X direction is a right side, a −X direction indicates a left side, a +Y direction indicates a front side, a −Y direction indicates a rear side (back side), a +Z direction indicates an upper side, and a −Z direction indicates a lower side.

### First Embodiment

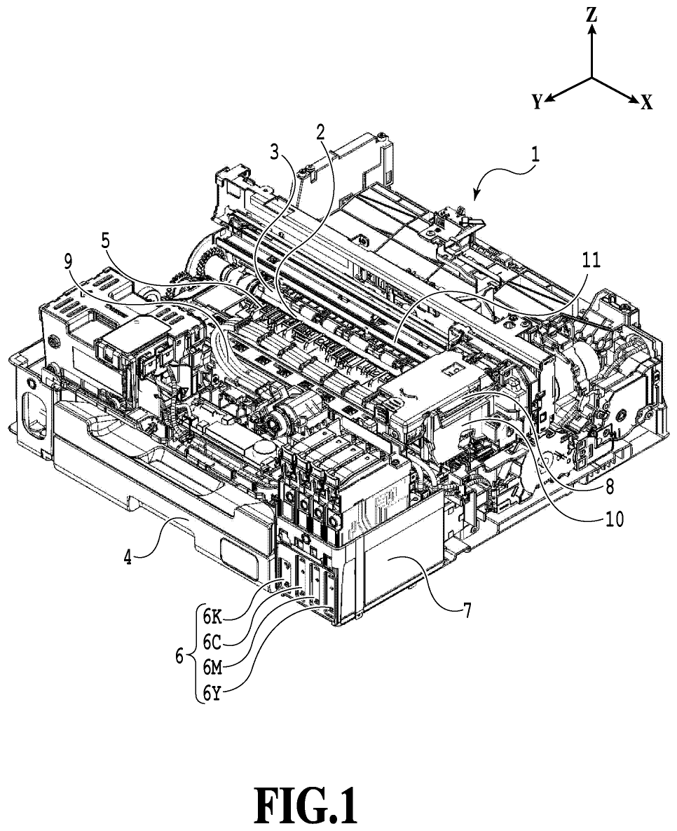

Hereinafter, an outline of an inkjet printing apparatus according to the present embodiment will be described by using FIG. 1.

A printing apparatus 1 includes a conveyance roller 2 extended in the X direction, a pinch roller 3 biased to the conveyance roller 2 and driven by the conveyance roller 2, a cassette 4 configured to load printing media, and a platen 5 configured to support a printing medium. Each of the printing media loaded on the cassette 4 is fed by a sheet feed roller (not illustrated) and guided between the conveyance roller 2 and the pinch roller 3. Then, with rotations of the conveyance roller 2, the printing medium is conveyed in the +Y direction on the platen 5. The printing medium is further guided between a delivery roller (not illustrated) and spur rollers to be driven by the delivery roller. After the image is printed on the printing medium on the platen 5, the printing medium is delivered to the outside of the apparatus with rotations of the delivery roller. The printing apparatus may be referred to as a “liquid consumption apparatus” in view of a feature where the printing apparatus consumes liquids such as inks for printing on a printing medium.

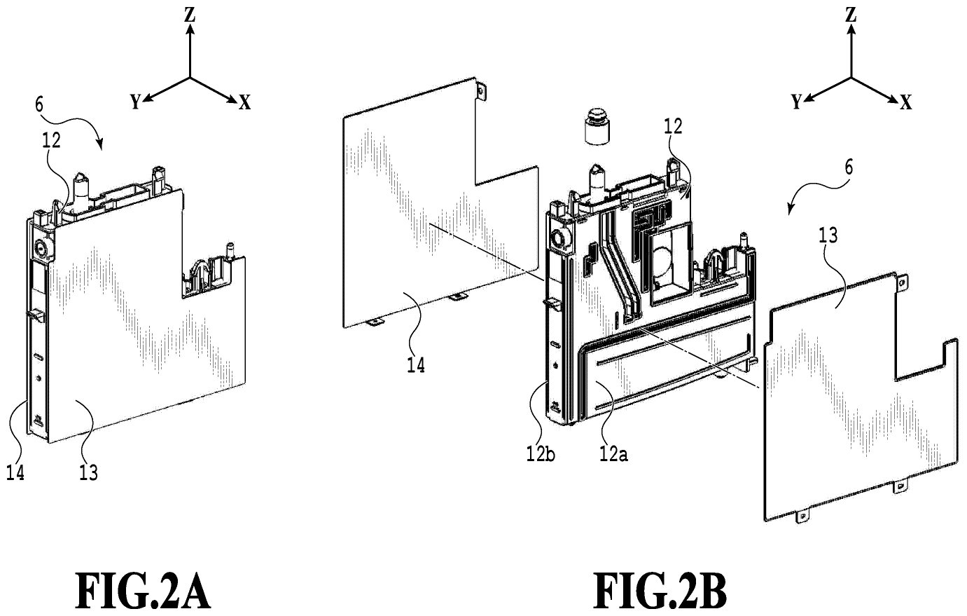

Ink tanks 6K, 6C, 6M, and 6Y (hereinafter, will be referred to as the ink tank 6 or ink tanks 6 in the case they are collectively expressed or do not have to distinguished. The same expression rule will be also applied to other constituent elements) are liquid containers configured to store inks. K denotes black, C denotes cyan, M denotes magenta, and Y denotes yellow. The ink tanks 6C, 6M, and 6Y have the same shape, whereas the ink tank 6K is different in size from these ink tanks but has the same basic structure. Since the ink tanks 6 are provided on the front side of the printing apparatus 1, a user can check the amounts of the remaining inks in tank cases 12 in the ink tanks 6 (see FIGS. 2A and 2B) by viewing the front side of the printing apparatus 1. The ink tank may be also referred to as a “liquid tank”, “liquid container”, or the like in view of a feature where the ink tank stores a liquid such as an ink.

In the case where the amount of any of the remaining inks decreases, the user can replenish the ink tank 6 fixed to a housing 7 with the ink by replacing an ink bottle (not illustrated). The four ink tanks store different colors of inks. Specifically, the ink tank 6K stores a black ink, the ink tank 6C stores a cyan ink, the ink tank 6M stores a magenta ink, and the ink tank 6Y stores a yellow ink. Here, the number of ink tanks is not limited to four as in the present embodiment, but may be equal to or more than the number corresponding to ink types. The ink bottle may be also referred to as a “(liquid) bottle” in view of a feature where the ink bottle stores a liquid such as an ink.

A print head 8 is for ejecting the inks onto a printing medium, and an ejection surface in which nozzles configured to eject the inks are formed is provided in a lower surface of the print head 8 so as to face the platen 5. Each nozzle is provided with an electrothermal transducer element (heater). With application of electricity, the electrothermal transducer element generates heat to foam the ink and ejects the ink with the foaming energy. The print head 8 may be configured to eject the inks by using piezoelectric transducer elements (piezo elements) in place of the electrothermal transducer elements. The print head 8 is supplied with the inks via tubes 9 provided between the print head 8 and the ink tanks 6. Since the tubes 9 are provided for the respective ink types, and there are four tubes 9 in the present embodiment. The print head may be also referred to as a “liquid ejection head” in view of a feature where the print head ejects liquids such as inks from the nozzles.

A carriage 10 supports the print head 8. The carriage 10 is capable of reciprocating in the X directions (the main scanning directions) while being guided along a guide rail 11. While the carriage 10 is moving, the print head 8 ejects the inks from the nozzles onto a printing medium on the platen 5 and thereby prints an image on the printing medium. This operation is referred to as “print scanning”. A printing operation is performed by alternately repeating a conveyance operation of the printing medium by the conveyance roller 2 and the printing scanning.

The printing apparatus 1 in the present embodiment is a serial-type inkjet printing apparatus equipped with the print head 8 mounted on the carriage 10 configured to reciprocate in the X directions as described above. However, the technique according to the present disclosure is also applicable to other types of printing apparatuses such as an inkjet printing apparatus including a so-called full-line type of print head in which multiple nozzles configured to eject inks are provided over a region corresponding to the width of a printing medium.

Next, the ink tank 6 will be described in detail by using FIGS. 2A and 2B. FIG. 2A is a perspective view of the ink tank and FIG. 2B is an exploded view of the ink tank.

The ink tank 6 includes a tank case 12 and right and left filters that are a film 13 and a film 14 different from the film 13 in X-direction position.

The tank case 12 is made of a transparent resin material and allows a user to see the amounts of the remaining inks thereinside. In the present embodiment, the resin material of the tank case 12 is specifically polypropylene. The film 13 is glued to a side portion 12a of tank case 12 and the film 14 is glued to a side portion 12b of the tank case 12, thereby covering opening portions of the tank case 12 and forming a closed space. In the present embodiment, the contact surfaces of the films 13 and 14 with the tank case 12 are made of the same material as the tank case 12, and they are mutually solved in heat welding and form an intimate contact state.

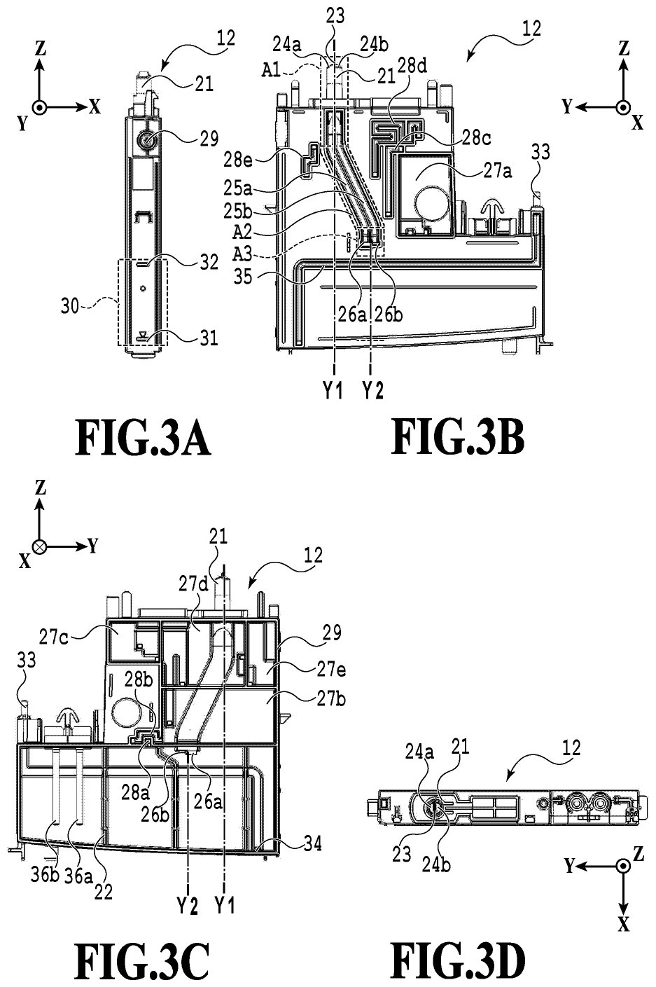

Next, the tank case 12 will be described in detail by using FIGS. 3A to 3D. FIG. 3A is a front view seen from the +Y direction, FIG. 3B is a right-side view, FIG. 3C is a left-side view, and FIG. 3D is a top view.

An inlet portion 21 is for pouring an ink in a bottle into a tank chamber 22. The inlet portion 21 is in a tubular shape protruding in the +Z direction and is formed integrally with the tank case 12. A tip end of the inlet portion 21 is partitioned by a wall 23 into a first inlet port 24a and a second inlet port 24b. The first inlet port 24a and the second inlet port 24b are provided outside and above the tank chamber 22.

The ink poured from the first inlet port 24a flows to a first outlet port 26a via a first inlet channel 25a. The ink poured from the second inlet port 24b flows to a second outlet port 26b via a second inlet channel 25b. The first outlet port 26a and the second outlet port 26b are provided inside the tank chamber 22. In the present embodiment, the two channels connecting the bottle and the tank chamber 22 inside the ink tank are provided as described above.

As the ink flows from the bottle to the ink tank, the negative pressure in the bottle increases and one of the channels is blocked with a surface tension of the ink. In the case where the channel is blocked, air flows into the bottle via the other channel (specifically, from the inlet port 24 via the outlet port 26 and the inlet channel 25 of the other channel). This causes the ink to additionally flow into the blocked channel. As the weight of the ink itself exceeds the surface tension, the blocked state is resolved and the ink flows into the tank chamber 22. Eventually, the ink flows into the tank chamber 22 up to a height at which air-liquid exchange cannot be performed any more, that is, a height at which the ink closes the first outlet port 26a and the second outlet port 26b.

As described above, in order that one of the two channels in the ink tank can function as an ink inlet channel and the other channel can function as an air outlet channel, a portion that can be blocked with the surface tension of the ink needs to be provided somewhere in the channel within a range from the inlet port 24 to the outlet port 26. In this regard, the smaller the cross-sectional area of the channel, the easier the channel is to block. However, in the case where the cross-sectional area is too small, the inflow velocity will decrease, so it is desirable to make the cross-sectional area as large as possible within a range that allows blockage of the channel. Whether the channel can be actually blocked depends on the cross-sectional shape, cross-sectional area, and so on of the channel. Regarding the cross-sectional areas of representative elements in the present embodiment, the first inlet port 24a and the second inlet port 24b are each about 10 mm², the first inlet channel 25a and the second inlet channel 25b are each about 13 mm², and the first outlet port 26a and the second outlet port 26b are each about 9 mm².

Each inlet channel 25 is formed to extend from the inlet port 24 to the outlet port 26 while having such a continuously vertically downward component that the ink can flow into the inlet channel 25 without any stagnation. The inlet channel 25 in the present embodiment extends from the inlet port 24 vertically downward (in the −Z direction) (area A1 in FIG. 3B), then partially tilts in the −Y direction (area A2 in FIG. 3B), and again extends vertically downward to the outlet port 26 (area A3 in FIG. 3B). An inflection point in the inlet channel 25 at which the channel direction is changed is desirably formed in an R shape achieving such a smooth connection as not to impede the flow of the ink. The channel shape should not be limited to the aforementioned shape, but may be any shape continuously extending vertically downward (in the −Z direction). For example, the inlet channel 25 may tilt in the −Y direction immediately from a portion near the inlet port 24 and reaches the outlet port 26 without changing the tilt angle.

A buffer chamber 27 is a space for temporarily receiving the ink in the tank chamber 22 so as to prevent the ink from leaking out of the ink tank 6 under a condition where the printing apparatus 1 is at a posture different from a posture for use. In the present embodiment, five buffer chambers, namely, first to fifth buffer chambers 27a to 27e are provided and each of the buffer chambers is continuously connected to the tank chamber 22 via a channel.

Specifically, the tank chamber 22 is continuously connected to the first buffer chamber 27a via a first channel 28a. The tank chamber 22 is continuously connected to the second buffer chamber 27b via a second channel 28b. The tank chamber 22 is continuously connected to the third buffer chamber 27c via a third channel 28c. The tank chamber 22 is continuously connected to the fourth buffer chamber 27d via a fourth channel 28d. The tank chamber 22 is continuously connected to the fifth buffer chamber 27e via a fifth channel 28e.

An air communication hole 29 is formed in the front surface of the tank case 12 (the +Y direction side). The air communication hole 29 communicates with the tank chamber 22 via the aforementioned first to fifth buffer chambers 27a to 27e and the aforementioned first to fifth channels 28a to 28e. Thus, even though the printing apparatus 1 is at a posture different from the posture for use, the ink inside the tank chamber 22 can be prevented from leaking out from the air communication hole 29.

In addition, the front surface of the tank case 12 is provided with a viewing surface 30 through which the user can visually check the amount of the remaining ink. The viewing surface 30 is formed of a material through which the user can visually check the amount of the remaining ink in the tank chamber 22 (for example, a transparent resin). On the viewing surface 30, a lower limit gauge 31 representing an indicator of the lower limit of the amount of the remaining ink as an ink replenishment timing, and an upper limit gauge 32 representing an indicator of the upper limit in ink replenishment are formed in protruding or recessed shapes.

A liquid delivery port 33 for delivering the ink to the print head 8 is formed on the rear side of the tank case 12. The liquid delivery port 33 and the tank chamber 22 communicate with each other via an opening portion 34 and a delivery channel 35, and the aforementioned tube 9 is connected to the liquid delivery port 33. Through this tube 9, the ink inside the tank case 12 is supplied to the print head 8.

Further, as illustrated in FIG. 3C, a pair of metallic pins 36a and 36b for detecting the amount of the remaining ink in the tank chamber 22 are provided on the rear side of the tank case 12. The metallic pins 36a and 36b are both connected to an electric board not illustrated. Whether the ink remains or not is detected based on a difference between an electrical resistance between the metallic pins dipped in the ink and an electrical resistance between the metallic pins outside the ink.

Here, description will be given of the positions of the inlet port 24 (the first and second inlet ports 24a and 24b) and the outlet port 26 (the first and second outlet ports 26a and 26b). In the tank case 12, the positions of the inlet port 24 and the outlet port 26 in the longitudinal direction (will be also referred to as Y-direction positions or depth-direction positions) are desired to be both set to optimal positions in consideration of the layout of the aforementioned buffer chambers 27, air communication hole 29, metallic pins 36, and so on. In the present embodiment, the Y-direction center (Y1a) of the first inlet port 24a and the Y-direction center (Y2a) of the first outlet port 26a are provided at positions different in the longitudinal direction, and more specifically, Y2a is closer to the center of the tank chamber 22 than Y1a is. Similarly, the Y-direction center (Y1b) of the second inlet port 24b and the Y-direction center (Y2b) of the second outlet port 26b are provided at positions different in the longitudinal direction, and more specifically, Y2b is closer to the center of the tank chamber 22 than Y1b is. In this way, the Y-direction center Y1 of the inlet port 24 and the Y-direction center Y2 of the outlet port 26 are provided at the positions different in the longitudinal direction. Specifically, the outlet port 26 is provided closer to the center of the tank case 12 than the inlet port 24 is. More specifically, the outlet port 26 is provided at approximately the center of the tank chamber 22 in the longitudinal direction. With this structure, the positions of the inlet port 24 and the outlet port 26 in the longitudinal direction can be both set to the optimal positions, as will be described in detail below. The dimension of the tank chamber 22 in the depth direction (Y direction) is larger than the dimension of the tank chamber 22 in the right-left direction (X direction).

In general, the position of the inlet port 24 is desired to be a position where the user can easily perform an ink replenishment operation. In the present embodiment, as illustrated in FIG. 3B and so on, the inlet port 24 is arranged on the front side of the tank case 12, in other words, the +Y direction side, which is the front side of the printing apparatus 1. On the other hand, the outlet port 26 is provided closer to the center of the tank chamber 22 in the longitudinal direction (Y direction) than the inlet port 24 is. This positional relationship in the longitudinal direction (the positional relationship between the inlet port 24 and the outlet port 26) is an important feature of the present embodiment.

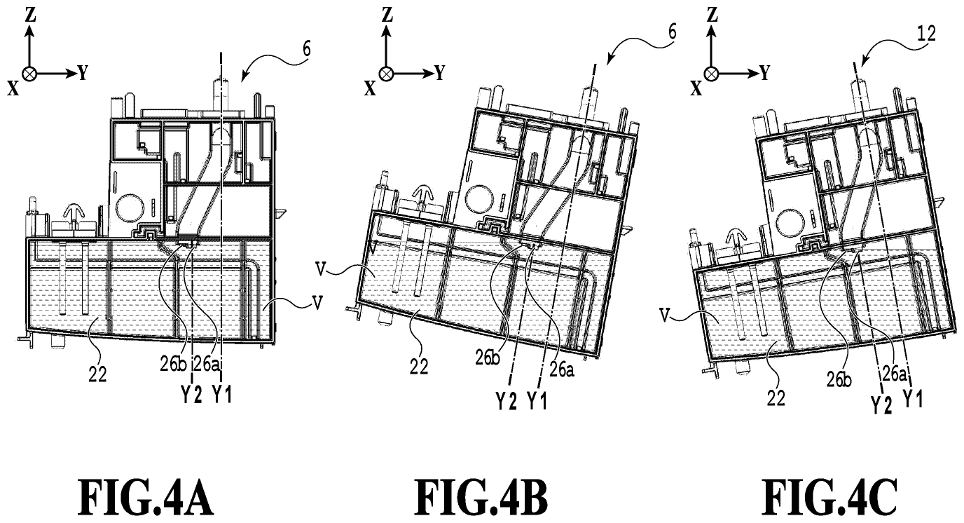

FIGS. 4A to 4C are views illustrating states in the tank chamber 22 under conditions where the ink tank 6 is tilted by rotating about the X axis. FIG. 4A illustrates a state where the ink tank 6 is not tilted, FIG. 4B illustrates a state where the ink tank 6 is tilted by rotating approximately 10 degrees clockwise about the X axis, and FIG. 4C illustrates a state where the ink tank 6 is tilted by rotating approximately 10 degrees anticlockwise about the X axis. FIGS. 4A to 4C illustrate the ink tank in the state where the films 13 and 14 are omitted for convenience of description.

As described above, the amount storable in the tank chamber 22 of the ink tank 6 is equivalent to an amount in which the liquid level of the ink stored through the air-liquid exchange function reaches the height of the outlet port 26. Meanwhile, in the case where the ink tank 6 is tilted by rotating about the X axis, the height of the outlet port 26 relative to the liquid surface changes depending on the tilt. Accordingly, the storable ink amount (denoted by V) in the ink tank 6 varies depending on the tile of the ink tank 6.

In the present embodiment, as illustrated in FIGS. 4A to 4C, the Y-direction position Y2 of the outlet port 26 is arranged as close as possible to the center of the tank chamber 22. As a result, as compared with the case where the Y-direction position Y2 of the outlet port 26 is arranged on the front end side (or the rear end side) of the tank chamber 22, a variation in the ink amount V with a tilt of the ink tank 6 can be reduced.

In other words, a difference in the amount of the ink stored in the tank chamber 22 between FIGS. 4B and 4C illustrating the states where the ink tank 6 is tilted (the amount of the ink stored is illustrated with dashed-lines) can be made smaller than in the case described in Japanese Patent Laid-Open No. 2019-104163. As a result, a variation in the replenishment amount depending on a tilt of the ink tank can be reduced, so that the replenishment amount can be made stable irrespective of the tilt. In Japanese Patent Laid-Open No. 2019-104163, the Y-direction position Y2 of the outlet port 26 is arranged on the front end side (or the rear end side) of the tank chamber 22 as described above.

Although the above description is given of the structure in which the Y-direction center Y1 of the inlet port 24 is arranged on the front side while the Y-direction center Y2 of the outlet port 26 is arranged on the center side, a structure to which the technique according to the present disclosure is applicable is not limited to this. For example, in a case where the buffer chambers 27 are arranged on the front side of the tank case 12 and the metallic pins 36 are arranged on the center side of the tank case 12, the volume of the tank case 12 can be efficiently used with a structure in which the Y-direction center Y1 of the inlet port 24 is arranged on the center side and the Y-direction center Y2 of the outlet port 26 is arranged on the front side.

### Examples

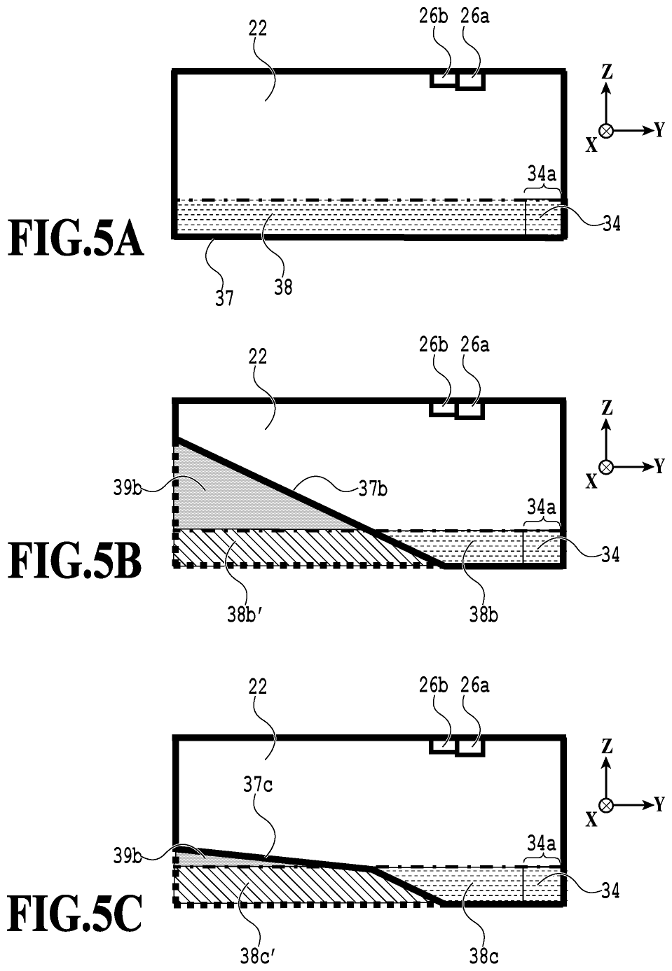

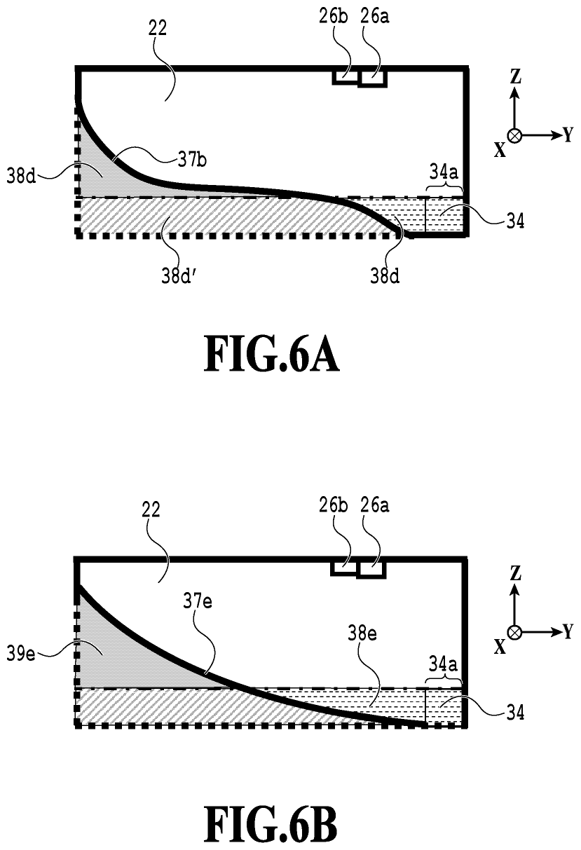

Hereinafter, with reference to FIGS. 5A to 5C, 6A, and 6B, description will be given of shapes of a bottom surface 37 constituting the tank chamber 22 together with the opening portion 34.

FIGS. 5A to 5C are schematic views of cross sections of various tank chambers 22, where FIG. 5A illustrates a tank chamber whose bottom surface 37 is horizontal, whereas FIGS. 5B and 5C each illustrate a tank chamber whose bottom surface 37 partially slopes. Specifically, FIG. 5B illustrates the tank chamber in which the bottom surface 37 includes one sloping surface and a horizontal surface having the lowest height in the tank chamber (hereinafter referred to as the lowest horizontal surface), and FIG. 5C illustrates the tank chamber in which the bottom surface 37 includes two sloping surfaces and a lowest horizontal surface.

FIGS. 6A and 6B illustrate schematic views of cross sections of various tank chambers 22, where FIGS. 6A and 6B both illustrate the tank chambers 22 in each of which the bottom surface 37 has an arc shape.

The opening portion 34 functions as an outlet port through which the ink inside the tank chamber 22 flows to the outside. To this end, the opening portion 34 is usually provided at the lowest position in the tank chamber 22. In the present examples, the opening portion 34 is provided in a side wall of the tank chamber 22 so as to be connected to the lowest horizontal surface. In addition, the opening portion 34 is provided on the forefront side (the +Y side) in the longitudinal (depth) direction.

In the present examples, the opening portion 34 has a rectangular opening shape. For this reason, in a case where the ink is supplied to the print head 8 in a state where the liquid level of the ink is at a position lower than an upper side 34a of the opening shape, air is mixed into the supplied ink, and adversely affects the ejection performance of the print head 8. For this reason, in order to prevent the liquid level of the ink from falling below the upper side 34a, it is usually necessary to prompt the user to replenish the ink tank 6 with the ink by warning the user. In other words, in the related art, the ink whose liquid level is located at the height of the upper side 34a of the opening portion 34 illustrated in FIG. 5A is in a state where the ink is unusable by the user. Here, the ink in this state will be referred to as unusable ink. In the case where the amount of the unusable ink 38 is large, the height of the liquid level viewable by the user greatly varies due to a tilt of the ink tank (see FIGS. 4B and 4C). Accordingly, the user may be confused in using the printing apparatus 1.

To address this, one conceivable method for reducing the unusable ink is to form a part of the bottom surface 37 in a sloping shape as illustrated in FIG. 5B. With this method, the amount of the unusable ink 38 illustrated in FIG. 5A can be reduced to the amount of the unusable ink 38b by an amount corresponding to a hatched area 38b′ However, the bottom surface 37b as described above brings about a disadvantage that the amount of the ink usable by the user (referred to as the effective ink) in the case where the liquid level of the ink is located above the upper side 34a of the opening portion 34 is reduced by an amount corresponding to a gray area 39b illustrated in FIG. 5B.

As a countermeasure for decreasing a reduction in the effective ink, it is conceivable to form a bottom surface in a shape having multiple sloping surfaces as in a bottom surface 37c illustrated in FIG. 5C. The bottom surface 37c includes a lowest horizontal surface, a first sloping surface connected to the lowest horizontal surface, and a second sloping surface connected to the first sloping surface. Thus, provided that the Z-direction position (height) of the upper side 34a of the opening portion 34 is defined as a boundary, the second sloping surface above the boundary has a gentler slope than that of the first sloping surface below the boundary. This structure makes it possible to decrease a reduction in the effective ink while decreasing an increase in the unusable ink 38c.

However, the tank chamber 22 employing the foregoing bottom surface using the sloping surface or surfaces resultantly has a capacity greatly reduced from the capacity that the tank chamber 22 could otherwise have. In addition, in the case where the bottom surface is formed of multiple sloping surfaces, the efficiency of collecting the ink may be impaired due to a discontinuous connection between one of the sloping surfaces and another sloping surface.

One conceivable structure for solving the above problem is a structure in which the bottom surface includes a lowest horizontal surface and a curved surface having a continuous curved shape with one inflection point as in a bottom surface 37d in FIG. 6A. The height of this inflection point is equal to the height of the upper side 34a of the opening shape. The foregoing case is that there is one inflection point, but the bottom surface may be formed by using a curved surface having multiple inflection points.

However, the structure in FIG. 6A also has a problem. This problem is based on the moldability of a plastic ink tank. Specifically, in the case where the box shape of the ink tank 6 causes a warp or the like in a direction of decreasing the capacity of the tank chamber 22 (in the inward direction of the ink tank) due to deformation over time, the ink tank 6 cannot store the desired amount of the ink, which is disadvantageous to the user. In the present specification, the “inflection point” means a point at which “a curve convex to the upper side” is changed to “a curve convex to the lower side”.

To address this, it is conceivable to form the bottom surface of a curved surface having an arc shape convex to the lower side as in a bottom surface 37e in FIG. 6B. Use of this structure makes it possible to make the amount of the unusable ink smaller than in FIG. 5B, suppress a reduction in the amount of the effective ink to a level comparable to or smaller than that in FIG. 5B, and also reduce a variation in molding. In sum, the use of the structure in FIG. 6B makes it possible to make the amount of the unusable ink smaller than in FIG. 5A and suppress a reduction in the amount of the effective ink as compared with that in FIG. 5B. Moreover, it is possible to reduce a variation in the ink capacity of the ink container depending on moldability.

According to the present disclosure, it is possible to stabilize a replenishment amount of a liquid irrespective of a tilt of a liquid container.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-119681, filed Jul. 24, 2023, which is hereby incorporated by reference wherein in its entirety.

What is claimed is:

1. A liquid container which is mounted on a liquid consumption apparatus including a liquid ejection head configured to eject a liquid and which is configured to store the liquid to be supplied to the liquid ejection head, the liquid container comprising:
a tank chamber configured to store the liquid;
an inlet port which is provided above the tank chamber and into which the liquid is poured; and
an outlet port which is provided to face an inside of the tank chamber and from which the liquid poured from the inlet port is discharged after moving through a channel along with air-liquid exchange, wherein
provided that a depth direction is a direction crossing a height direction and a right-left direction of the liquid consumption apparatus, a depth-direction center position of the outlet port is closer to a center of the tank chamber than a depth-direction center position of the inlet port.

2. The liquid container according to claim 1, wherein from a bottle attached to the liquid consumption apparatus, the ink is supplied to the tank chamber via the inlet port, the channel, and the outlet port.

3. The liquid container according to claim 2, wherein, in the depth direction, the outlet port is provided closer to a center of the liquid consumption apparatus than the inlet port is.

4. The liquid container according to claim 3, wherein the outlet port is provided at approximately the center of the tank chamber in the depth direction.

5. The liquid container according to claim 1, wherein, in the depth direction, the inlet port is provided on an outer side of the liquid consumption apparatus as compared with the outlet port.

6. The liquid container according to claim 2, wherein the channel is formed to extend from the inlet port to the outlet port while having a continuously vertically downward component.

7. The liquid container according to claim 6, wherein
the inlet port includes a first inlet port and a second inlet port,
the channel includes a first channel and a second channel,
the outlet port includes a first outlet port and a second outlet port,
the liquid poured from the first inlet port flows through the first channel and is discharged from the first outlet port, and
the liquid poured from the second inlet port flows through the second channel and is discharged from the second outlet port.

8. The liquid container according to claim 7, wherein in a case where any one of the first channel and the second channel is blocked, air flows into the bottle through the other channel not blocked.

9. The liquid container according to claim 8, further comprising an air communication hole and a buffer chamber, wherein
the air communication hole communicates with the tank chamber through the buffer chamber.

10. The liquid container according to claim 1, wherein
the tank chamber includes a bottom surface and an opening portion from which the liquid inside the tank chamber flows out,
the bottom surface includes at least a lowest horizontal surface, and
the opening portion is provided in a side wall of the tank chamber so as to be connected to the lowest horizontal surface.

11. The liquid container according to claim 10, wherein in the depth direction, the outlet port is provided closer to a center of the liquid consumption apparatus than the opening portion is.

12. The liquid container according to claim 10, wherein the bottom surface includes the lowest horizontal surface and one sloping surface.

13. The liquid container according to claim 10, wherein the bottom surface includes the lowest horizontal surface, a first sloping surface connected to the lowest horizontal surface, and a second sloping surface having a gentler slope than a slope of the first sloping surface.

14. The liquid container according to claim 13, wherein the opening portion has a rectangular opening shape,
a height of an upper side of the opening shape is equal to a height of a position at which the first sloping surface is connected to the second sloping surface.

15. The liquid container according to claim 10, wherein the bottom surface includes the lowest horizontal surface and a curved surface.

16. The liquid container according to claim 15, wherein
the opening portion has a rectangular opening shape, and
the curved surface has one inflection point, and
a height of an upper side of the opening shape is equal to a height of the one inflection point.

17. The liquid container according to claim 15, wherein
the curved surface has a plurality of inflection points.

18. The liquid container according to claim 15, wherein the curved surface has an arc shape convex to a lower side.

19. The liquid container according to claim 1, wherein
a dimension of the tank chamber in the depth direction is larger than a dimension of the tank chamber in the right-left direction.

20. A liquid consumption apparatus comprising:
a liquid ejection head configured to eject a liquid; and
a liquid container configured to store the liquid to be supplied to the liquid ejection head, wherein
the liquid container comprises:
a tank chamber configured to store the liquid;
an inlet port which is provided above the tank chamber and into which the liquid is poured; and
an outlet port which is provided to face an inside of the tank chamber and from which the liquid poured from the inlet port is discharged after moving through a channel along with air-liquid exchange, and
provided that a depth direction is a direction crossing a height direction and a right-left direction of the liquid consumption apparatus, a depth-direction center position of the outlet port is closer to a center of the tank chamber than a depth-direction center position of the inlet port.
